(19) United States
(12) Patent Application Publication
(10) Pub. No.: US 2009/0316542 A1
(43) Pub. Date: Dec. 24, 2009

(54) INFORMATION RECORDING DEVICE AND METHOD, AND COMPUTER PROGRAM

(75) Inventor: Akira Shirota, Saitama (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/515,646

(22) PCT Filed: Nov. 24, 2006
(86) PCT No.: PCT/JP2006/323478

§ 371 Date: Jul. 15, 2009

(51) Int. Cl. G11B 7/00

(52) U.S. Cl. 369/47.5; 369/100; G9B/7

(57) ABSTRACT

An information recording device (1) is provided with recording element (3 and the like) for recording a recording mark by irradiating an information recording medium (100) with a laser beam; setting element (11 and the like) for setting recording conditions, corresponding to changes of the characteristics of the information recording medium with time; and control element (10 and the like) for controlling the recording element to record the recording mark under the set recording conditions.

### TECHNICAL FIELD

The present invention relates to an information recording apparatus and method, such as a DVD recorder, which record information onto an information recording medium, such as a DVD, and a computer program which makes a computer function as the information recording apparatus.

### BACKGROUND ART

For example, in optical discs, such as a CD, a DD-R/RW/RAM, a DVD+R, and a Blu-ray, information is recorded on the basis of their own written standards which define recording conditions (i.e. spec BOOKs). The “recording conditions” in the present invention denote recording parameters for recording the information (data) onto the optical discs: for example, a recording velocity (linear velocity and angular velocity); a recording power for a driving pulse including a top pulse and a middle pulse, which corresponds to the recording velocity; a pulse strategy corresponding to the recording velocity; and the like.

Patent document 1: Japanese Patent Application Laid Open No. 2003-85753

### DISCLOSURE OF INVENTION

### Subject to be Solved by the Invention

In the data recorded on the aforementioned optical discs, its reproduction quality is likely deteriorated as time pass from a moment immediately after the recording, in other words, with time immediately after the recording. In order to prevent the deterioration in the reproduction quality, many studies have been made on materials and composition for the recording layer of the optical disc.

However, in the studies on materials and composition for the recording layer of the optical disc, problematically, it is technically hard to more appropriately and less expensively prevent the deterioration in the reproduction quality with time from immediately after the recording. Moreover, problematically, there are many optical discs on the market that take no countermeasures to prevent the deterioration in the reproduction quality with time from immediately after the recording.

In view of the aforementioned problems, it is therefore an object of the present invention to provide an information recording apparatus and method capable of recording the record information on an information recording medium, such as an optical disc, while preventing the deterioration in the reproduction quality with time, as well as a computer program which makes a computer function as the information recording apparatus.

### Means for Solving the Subject

The above object of the present invention can be achieved by an information recording apparatus according to claim 1, provided with: a recording device for recording record information by applying a laser beam from a light source to an information recording medium and thus recording record marks with a plurality of types of lengths; a setting device for setting recording conditions in accordance with a change occurring the record marks with time; and a controlling device for controlling the recording device to record the record marks on the basis of the set recording conditions.

The above object of the present invention can be also achieved by an information recording method according to claim 20, provided with: a recording process of recording record information by applying a laser beam from a light source to an information recording medium and thus recording record marks with a plurality of types of lengths; a setting process of setting recording conditions in accordance with a change occurring the record marks with time; and a controlling process of controlling the recording process to record the record marks on the basis of the set recording conditions.

The above object of the present invention can be also achieved by a computer program according to claim 21, for recording control to control a computer provided for the information recording apparatus according to claim 1, the computer program making the computer function as at least one portion of the recording device, the setting device, and the controlling device.

The operation and other advantages of the present invention will become more apparent from the embodiments explained below.

### BEST MODE FOR CARRYING OUT THE INVENTION

Hereinafter, the information recording apparatus, the information recording method, and the computer program in embodiments of the present invention will be described in order.

### Embodiment of Information Recording Apparatus

An embodiment of the information recording apparatus of the present invention is an information recording apparatus provided with: a recording device for recording record information by applying a laser beam from a light source to an information recording medium and thus recording record marks with a plurality of types of lengths; a setting device for setting recording conditions in accordance with a change occurring the record marks with time; and a controlling device for controlling the recording device to record the record marks on the basis of the set recording conditions.

According to the embodiment of the information recording apparatus of the present invention, the record marks with the plurality of types of lengths are recorded by the laser beam applied from the light source, such as a semiconductor laser, provided for the recording device having an optical pickup or the like. Here, the “record marks with the plurality of types of lengths” in the present invention denote record marks with the plurality of types of lengths each of which is formed on the information recording medium in accordance with the magnitude of a thermal energy to which an energy of the laser beam applied on the information recording medium is converted. Specifically, as for the length of the record marks, the plurality of types of lengths such as “3T” to “14T” can be expressed by using a reference clock period “T”.

Simultaneously with or in tandem with the recording of the record marks, the recording conditions are set by the setting device in accordance with the change occurring in the record marks with time. Here, the “change occurring in the record marks” in the present invention denotes a change with time in the feature and shape of the record marks holding the record information which is determined on the basis of physical or chemical properties of the recording layer which constitutes the information recording medium, such as a composition formula and a material for the recording layer. Moreover, the “recording conditions” in the present invention denote various irradiation conditions for the laser beam, such as a recording strategy, light quantity, or recording power of the laser beam applied to record (or form) the predetermined record marks onto the information recording medium, in order to record the record information onto the information recording medium.

Then, under the control of the controlling device, the record marks are recorded by the recording device having an optical pickup or the like, on the basis of the set recording conditions.

In particular, in the embodiment, the recording conditions are set by the setting device in accordance with the change occurring in the record marks with time. Therefore, it is possible to almost or completely prevent that the reproduction quality of the record marks (or record information held in the record marks) recorded on the recording conditions is deteriorated (or changed) with time. Incidentally, the reproduction quality may be indicated by various quality values, such as an asymmetry value, a jitter value, degree of modulation, an incidence of a reproduction error (i.e. a reproduction error rate), and an optical reflectance.

As a result, by appropriately responding to the change occurring in the record marks with time on the information recording medium, the information recording apparatus can record the record information having the appropriate reproduction quality which is not deteriorated with time.

As a result, it is possible to remarkably improve the reproduction quality and reliability of the record information recorded on the information recording medium by the information recording apparatus, leading to a remarkably long lifetime of the information recording medium.

In one aspect of the embodiment of the information recording apparatus of the present invention, the setting device sets the recording conditions to change a mark length of the shortest or second shortest record mark, of the plurality of types of lengths (e.g. on the basis of a standard mark length).

According to this aspect, the information recording apparatus can record the record information having the appropriate reproduction quality which is not deteriorated with time, onto the information recording medium, on the basis of the change based on the standard mark length in the shortest or second shortest record mark, in accordance with the change occurring in the record marks with time. Here, the “standard mark length” in the present invention denotes the mark length of the shortest record mark which can provide the good reproduction quality of the record information including the shortest or second shortest record mark, immediately after the recording. More specifically, it may be the mark length of the shortest or second shortest record mark formed under a standard rotational speed of the information recording medium which is determined by the standards, for example, in accordance with the type of the information recording medium. Incidentally, the standard mark length may be defined, individually and specifically, on an experimental, theoretic, experiential, or simulation basis.

Specifically, the setting device may set (i) the recording conditions such that the mark length of the record marks is longer than a predetermined mark length if a change in an asymmetry value which indicates the reproduction quality corresponding to the change occurring in the record marks with time on the information recording medium is reduced with time, and (ii) the recording conditions such that the mark length of the record marks is shorter than the predetermined mark length if the change in the asymmetry value is increased with time.

As a result, the information recording apparatus can respond to the change occurring in the record marks with time on the information recording medium, more highly accurately and appropriately.

In an aspect associated with the setting device, the setting device may set the recording conditions to change the mark length by changing a pulse width of a pulse signal which drives the light source.

By virtue of such construction, the information recording apparatus can record the record information having the appropriate reproduction quality which is not deteriorated with time, onto the information recording medium, on the basis of the shortest or second shortest record mark recorded with the pulse width set to be changed on the basis of a predetermined width. Here, the “predetermined width” in the present invention denotes, for example, the pulse width of the pulse signal for recording the shortest or second shortest record mark which can provide the good reproduction quality of the record information including the shortest or second shortest record mark, immediately after the recording. Incidentally, the predetermined width may be defined, individually and specifically, on an experimental, theoretic, experiential, or simulation basis.

In an aspect associated with the setting device, the setting device may set the recording conditions to change the mark length by changing a recording power or light quantity of the laser beam applied from the light source.

By virtue of such construction, the information recording apparatus can record the record information having the appropriate reproduction quality which is not deteriorated with time, onto the information recording medium, on the basis of the shortest or second shortest record mark recorded with the recording power or light quantity set to be changed on the basis of a predetermined recording power or predetermined light quantity. Here, the “predetermined light quantity” in the present invention denotes, for example, the light quantity of the laser beam for recording the shortest or second shortest record mark which can provide the good reproduction quality of the record information including the shortest or second shortest record mark, immediately after the recording. Moreover, the “predetermined recording power” in the present invention denotes, for example, the recording power of the laser beam for recording the shortest or second shortest record mark which can provide the good reproduction quality of the record information including the shortest or second shortest record mark, immediately after the recording. Incidentally, the predetermined light quantity or predetermined recording power may be defined, individually and specifically, on an experimental, theoretic, experiential, or simulation basis.

In an aspect associated with the setting device, it may be further provided with an optimum light quantity determining device for determining an optimum recording power or light quantity for the information recording medium by an OPC (Optimum Power Control) process, the setting device setting the recording conditions to apply the laser beam from the light source with a recording power or light quantity corresponding to 101% to 110% of the determined optimum recording power or light quantity.

By virtue of such construction, the information recording apparatus can record the record information having the more appropriate reproduction quality which is not deteriorated with time, onto the information recording medium, on the basis of the record marks recorded with the recording power or light quantity corresponding to 101% to 110% with the optimum recording power or light quantity used as a reference. Here, the “optimum light quantity” in the present invention denotes, for example, the light quantity of the laser beam for recording the shortest or second shortest record mark which can provide the optimum reproduction quality of the record information including the shortest or second shortest record mark, immediately after the recording. Moreover, the “optimum recording power” in the present invention denotes, for example, the recording power of the laser beam for recording the shortest or second shortest record mark which can provide the optimum reproduction quality of the record information including the shortest or second shortest record mark, immediately after the recording. Incidentally, the optimum light quantity or optimum recording power may be defined, individually and specifically, on an experimental, theoretic, experiential, or simulation basis.

In an aspect associated with the setting device, the setting device may set the recording conditions to change the mark length in accordance with a material for a recording layer of the information recording medium.

By virtue of such construction, the information recording apparatus can record the record information having the appropriate reproduction quality which is not deteriorated with time, onto the information recording medium, on the basis of the mark length changed in accordance with the material for the recording layer of the information recording medium.

Moreover, in an aspect associated with the setting device, it may be further provided with: a disc information obtaining device for obtaining disc attribute information about the information recording medium (a manufacturer's name, ID, or the like); and a specifying device for specifying the material for the recording layer of the information recording medium on the basis of the disc attribute information.

By virtue of such construction, the information recording apparatus can record the record information having the appropriate reproduction quality, more highly accurately and appropriately, on the basis of the mark length appropriately changed in accordance with the obtained disc attribute information and the specified material for the recording layer of the information recording medium. Here, the “disc attribute information” in the present invention denotes information which can identify the attribute and properties of the information recording medium, such as a name of a manufacturer which manufactures the information recording medium and a product identification number. Specifically, the disc information obtaining device firstly obtains the disc attribute information unique to an optical disc, such as a product identification number, to thereby specify, for example, a manufacturer and a maker. Then, the specifying device specifies the material from a correspondence table or the like on which manufacturers and materials for the recording layer of the optical disc are associated, which is stored in a memory device as a database. Thirdly, the setting device sets the mark length in accordance with the specified material.

In an aspect associated with the setting device, it may be further provided with a storage period determining device for determining a storage period of the record information recorded on the information recording medium, the setting device changing the mark length in accordance with the storage period.

According to this aspect, it is possible to record the plurality of types of record marks (record information or data) in a plurality of types of recording conditions corresponding to a plurality of types of storage periods. Therefore, it is possible to record the record marks whose reproduction quality is guaranteed, onto the information recording medium, in accordance with the length of the storage period.

As a result, it is possible to remarkably improve the reproduction quality and reliability of the record information recorded on the information recording medium by the information recording apparatus, leading to a remarkably long lifetime of the information recording medium.

In an aspect associated with the setting device, the storage period determining device may determine the storage period in accordance with a type of the record information.

By virtue of such construction, the length of the storage period may be determined on the basis of the type and characteristics of the record information held by the record marks. Specifically, if the record information held by the record marks is about medical records, securities, official certificates, and the like, the setting device may automatically or manually set long-term storage recording conditions. Alternatively, if the record information held by the record marks is about movie contents and the like, the setting device may automatically or manually set short-term storage recording conditions.

In an aspect associated with the setting device, the setting device may set the recording conditions to increase the mark length in accordance with a length of the storage period.

According to this aspect, it is possible to record the record marks (record information or data) with a long mark length in the recording conditions corresponding to, for example, a long-term storage period. Therefore, it is possible to record the record marks whose reproduction quality is guaranteed, onto the information recording medium, in accordance with the length of the storage period.

In an aspect associated with the setting device, it may be further provided with a strategy information obtaining device for obtaining strategy information including information about a standard pulse width of the pulse signal which drives the light source, the setting device setting the recording conditions to change the mark length by changing the pulse width on the basis of the standard pulse width corresponding to the obtained strategy information.

By virtue of such construction, the information recording apparatus can record the record information having the appropriate reproduction quality, more highly accurately and appropriately, on the basis of the appropriately changed mark length, with the standard pulse width used as a reference, wherein the standard pulse width corresponds to the obtained strategy information. Here, the “standard pulse width” in the present invention denotes, for example, the pulse width of the pulse signal which is determined in advance by a disc manufacturer and which is for recording the shortest or second shortest record mark which can provide the optimum reproduction quality of the record information including the shortest or second shortest record mark, immediately after the recording. Incidentally, the standard pulse width may be defined, individually and specifically, on an experimental, theoretic, experiential, or simulation basis.

In an aspect associated with the setting device, it may be further provided with a disc attribute information obtaining device for obtaining disc attribute information from the information recording medium and obtaining strategy information about the information recording medium on the basis of the obtained disc attribute information, the setting device setting the recording conditions to change the mark length by changing the pulse width on the basis of the standard pulse width corresponding to the obtained strategy information.

By virtue of such construction, the information recording apparatus can record the record information having the appropriate reproduction quality, more highly accurately and appropriately, on the basis of the appropriately changed mark length, with the standard pulse width used as a reference, wherein the standard pulse width corresponds to the strategy information further obtained by the obtained disc attribute information.

In another aspect of the embodiment of the information recording apparatus of the present invention, the setting device sets a first recording condition in which a change in reproduction quality corresponding to a temporal change in features of the information recording medium is relatively reduced, as the recording conditions.

According to this aspect, as for the recording conditions for recording the record marks, the first recording condition that the change in the reproduction quality corresponding to the temporal change in the features of the information recording medium is relatively reduced, is set as the recording conditions. Here, the “features of the information recording medium” in the present invention denote physical or chemical properties of the recording layer which constitutes the information recording medium before or after the record marks holding the record information are recorded, as well as denoting various properties of the information recording medium in a broad sense. Specifically, the features of the information recording medium may denote, for example, physical or chemical properties corresponding to a composition formula and material for the recording layer. Specifically, the first recording condition may be defined, on the basis of a correlation among an elapsed time, the reproduction quality, and the recording power. More specifically, if the recording conditions are the first recording condition, for example, the reproduction quality “immediately after the recording” and the reproduction quality “267 days after the recording or two hundreds and sixty seven” are both good. Incidentally, if a jitter value is adopted as the reproduction quality, it may be judged that the reproduction quality is good if the jitter value is less than about 8% which indicates a standard value. Therefore, by intentionally performing the recording in the first recording condition which is different from another recording condition and which provides the best reproduction quality immediately after the recording, it is possible to limit or control an influence of the temporal change in the features, and it is also possible to guarantee substantially the same reproduction quality as that immediately after the recording.

As a result, it is possible to set the recording conditions, quickly and appropriately.

In an aspect associated with the setting device, the setting device may set the recording conditions to change the mark length by increasing the pulse width.

By virtue of such construction, the information recording apparatus can record the record information having the more appropriate reproduction quality which is not deteriorated with time, onto the information recording medium, on the basis of the mark length of the record marks recorded with the pulse width set to be longer than the predetermined width.

In an aspect associated with the setting device, the setting device may set the recording conditions to change the mark length by increasing a recording power or light quantity of the laser beam applied from the light source.

By virtue of such construction, the information recording apparatus can record the record information having the more appropriate reproduction quality which is not deteriorated with time, onto the information recording j medium, on the basis of the mark length of the record marks recorded with the recording power set to be greater than the predetermined recording power.

In another aspect of the embodiment of the information recording apparatus of the present invention, the setting device sets the recording conditions to change a mark length of another record mark, except the shortest or second shortest record mark, of the plurality of types of lengths.

According to this aspect, the information recording apparatus can relatively change the mark length of the shortest or second shortest record mark, on the basis of the change in the mark length of another record mark, such as the longest record mark, except the shortest or second shortest record mark. As a result, the information recording apparatus can record the record information having the appropriate reproduction quality which is not deteriorated with time, onto the information recording medium, on the basis of a relative change in the mark length of the shortest or second shortest record mark, in accordance with the change occurring in the record marks with time.

In another aspect of the embodiment of the information recording apparatus of the present invention, the setting device sets the recording conditions after a predetermined recording power is detected for the information recording medium.

According to this aspect, the setting device can set the recording conditions, quickly and appropriately, on the basis of the detected predetermined recording power.

In another aspect of the embodiment of the information recording apparatus of the present invention, a temporal change in features of the information recording medium is shown by a predetermined table, and the predetermined table can be corrected by a correction coefficient.

According to this aspect, the setting device can set the recording conditions, quickly and appropriately, on the basis of the predetermined table which can be corrected by the correction coefficient.

In another aspect of the embodiment of the information recording apparatus of the present invention, the setting device (i) sets a short-term recording condition in accordance with a relatively short-term temporal change in features of the information recording medium and (ii) sets a long-term recording condition in accordance with a relatively long-term temporal change in the features of the information recording medium, and the controlling device controls the recording device to record the record marks on the basis of the set short-term recording condition and the set long-term recording condition.

According to this aspect, it is possible to record the plurality of types of record marks (record information or data) in a plurality of types of recording conditions corresponding to a plurality of types of storage periods, such as short-term recording conditions and long-term recording conditions. Therefore, it is possible to make the record marks whose reproduction quality is guaranteed, present on the information recording medium, without depending on the length of the storage period.

As a result, it is possible to remarkably improve the reproduction quality and reliability of the record information recorded on the information recording medium by the information recording apparatus, leading to a remarkably long lifetime of the information recording medium.

### Embodiment of Information Recording Method

Hereinafter, an information recording method in an embodiment of the present invention will be described.

The embodiment of the information recording method of the present invention is an information recording method provided with: a recording process of recording record information by applying a laser beam from a light source to an information recording medium and thus recording record marks with a plurality of types of lengths; a setting process of setting recording conditions in accordance with a change occurring the record marks with time; and a controlling process of controlling the recording process to record the record marks on the basis of the set recording conditions.

According to the embodiment of the information recording method of the present invention, it is possible to receive the same various benefits as those of the embodiment of the information recording apparatus of the present invention described above.

Incidentally, in response to the various aspects in the embodiment of the information recording apparatus of the present invention described above, the embodiment of the information recording method of the present invention can also adopt various aspects.

### Embodiment of Computer Program

Hereinafter, a computer program in an embodiment of the present invention will be described.

The embodiment of the computer program for recording control of the present invention is a computer program for recording control to control a, computer provided for the aforementioned embodiment of the information recording apparatus of the present invention (including its various aspects), the computer program making the computer function as at least one portion of the recording device, the setting device, and the controlling device.

According to the embodiment of the computer program of the present invention, the aforementioned embodiment of the information recording apparatus of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of in the embodiment of the information recording apparatus of the present invention described above, the embodiment of the computer program of the present invention can adopt various aspects.

The operation and other advantages of the present invention will become more apparent from the examples explained below.

As explained above, according to the embodiment of the information recording apparatus of the present invention, it is provided with the recording device, the setting device, and the controlling device. According to the embodiment of the information recording method of the present invention, it is provided with the recording process, the setting process, and the controlling process. As a result, the information recording apparatus and method can record the record information having the appropriate reproduction quality which is not deteriorated with time, onto the information recording medium, in appropriate accordance with the change occurring the record marks with time on the information recording medium. As a result, it is possible to remarkably improve the reproduction quality and reliability of the record information recorded on the information recording medium by the information recording apparatus, leading to a remarkably long lifetime of the information recording medium.

Moreover, according to the embodiment of the computer program of the present invention, since it makes a computer function as the embodiment of the information recording apparatus of the present invention, it is possible to enable the information recording apparatus to record the record information having the appropriate reproduction quality which is not deteriorated with time, onto the information recording medium, in appropriate accordance with the change occurring the record marks with time on the information recording medium.

### BRIEF DESCRIPTION OF DRAWINGS

FIG. 1 is a schematic plan view showing the structure of an optical disc having a plurality of areas in an example of the information recording medium of the present invention in an upper part, and a schematic conceptual view showing a recording area structure in the radial direction in accordance with the upper part, in a lower part.

FIG. 2 is a partially enlarged perspective view showing a recording surface of the optical disc in the example of the information recording medium of the present invention.

FIG. 3 is a block diagram conceptually showing the basic structure of an information recording/reproducing apparatus in an example of the information recording apparatus of the present invention.

FIG. 4 is a flowchart conceptually showing a recording operation flow of the information recording/reproducing apparatus in the example of the information recording apparatus of the present invention.

FIG. 5 is a schematic timing chart showing one OPC process, which is provided with 16 power steps, in the operation of the information recording/reproducing apparatus in the example of the information recording apparatus of the present invention.

FIG. 6 are a schematic diagram schematically showing a change in pulse width of a pulse signal (FIG. 6(a)) and a schematic diagram schematically showing a change in recording power of the pulse signal (FIG. 6(b)), as a change in recording strategy in the example.

FIG. 7 is a correspondence table to perform the change in recording strategy corresponding to the type or the like of the optical disc, as the change in recording strategy in the example.

FIG. 8 are (i) a table and a graph (FIG. 8(a) and FIG. 8(b)) showing a correlation between the recording power and reproduction quality immediately after the recording of record marks recorded on an optical disc in a comparison example and (ii) a table and a graph (FIG. 8(c) and FIG. 8(d)) showing a correlation between the recording power and the reproduction quality after 267 days of the record marks.

FIG. 9 are (i) a table and a graph (FIG. 9(a) and FIG. 9(b)) showing the correlation between the recording power and the reproduction quality immediately after the recording of record marks recorded on the optical disc in the example and (ii) a table and a graph (FIG. 9(c) and FIG. 9(d)) showing a correlation between the recording power and the reproduction quality after 267 days of the record marks.

FIG. 10 is a block diagram schematically showing the structure of a recording condition control device which performs the change in recording strategy in the example in accordance with a storage period of the optical disc.

FIG. 11 is a correspondence table to perform the change in recording strategy corresponding to the storage period of the optical disc, in addition to the type or the like of the optical disc, as the change in recording strategy in the example.

FIG. 12 is one flowchart conceptually explaining another recording operation flow of the information recording/reproducing apparatus in the example of the information recording apparatus of the present invention.

FIG. 13 is another flowchart conceptually explaining another recording operation flow of the information recording/reproducing apparatus in the example of the information recording apparatus of the present invention.

FIG. 14 is another flowchart conceptually explaining another recording operation flow of the information recording/reproducing apparatus in the example of the information recording apparatus of the present invention.

FIG. 15 is another flowchart conceptually explaining another recording operation flow of the information recording/reproducing apparatus in the example of the information recording apparatus of the present invention.

### DESCRIPTION OF REFERENCE CODES

1 information recording/reproducing apparatus
2 driving device
3 emitting device
4 light receiving device
5 slider device
6 radial position detection device
7 reproduction quality measurement device
8 recording poser selection device
9 disc information obtaining device
10 system control device (CPU)
11 recording condition control device
12 recording pulse generation device
100 optical disc
GT groove track
LT land track

### EXAMPLES

Hereinafter, examples of the present invention will be described on the basis of the drawings.

### (1) Example of Information Recording Medium

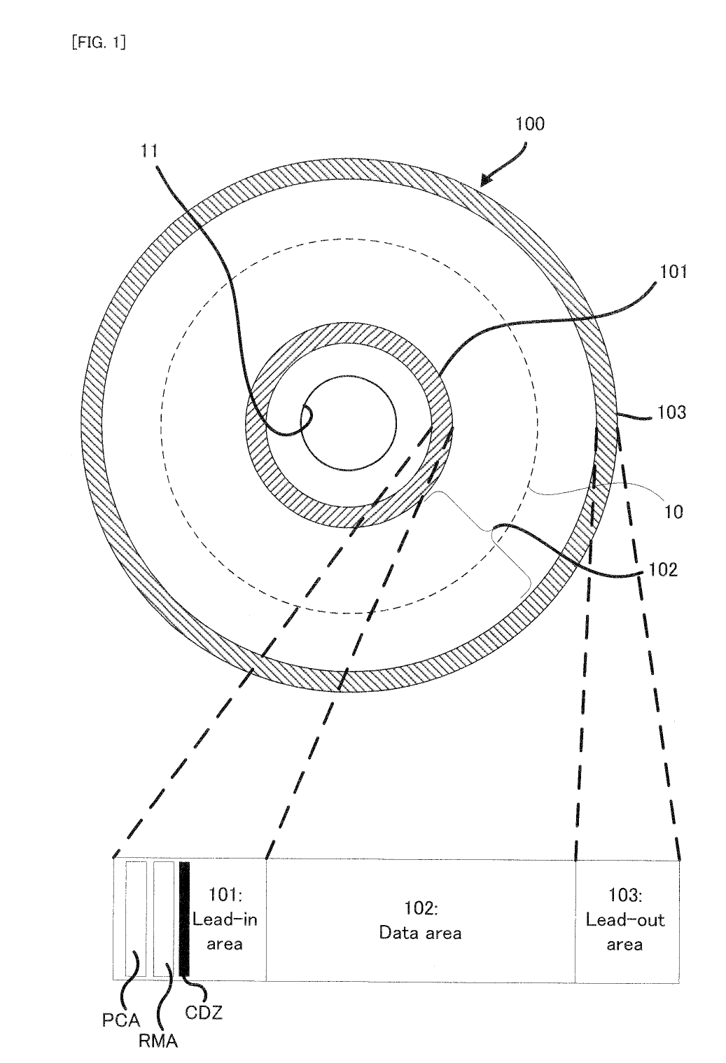

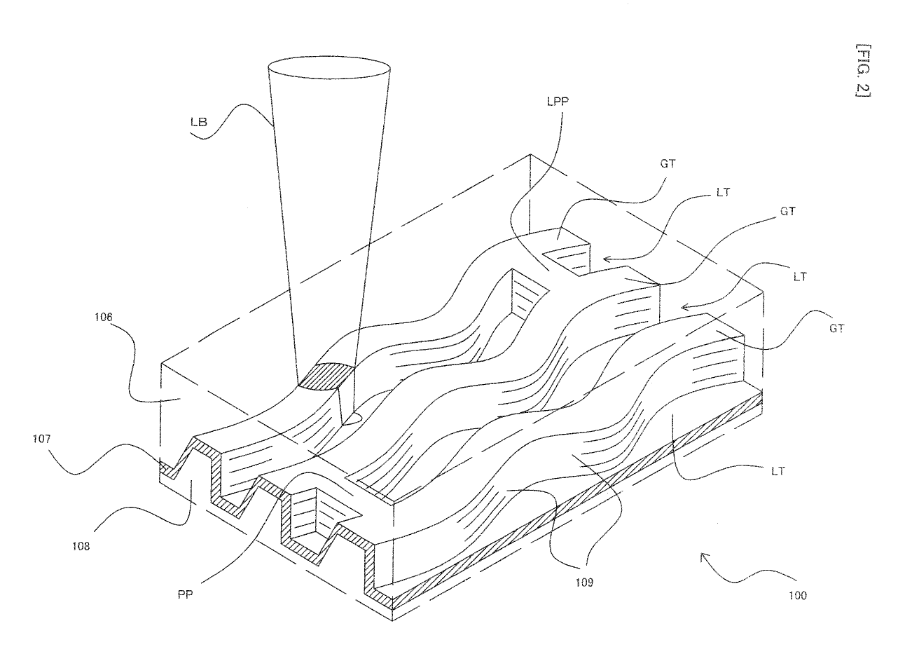

Firstly, with reference to FIG. 1 and FIG. 2, an example of the information recording medium of the present invention will be described in detail.

(1-1) Basic Structure

Firstly, with reference to FIG. 1, an explanation will be given on the basic structure of an optical disc in the example of the information recording medium of the present invention. FIG. 1 is a schematic plan view showing the structure of the optical disc having a plurality of areas in the example of the information recording medium of the present invention in an upper part, and a schematic conceptual view showing a recording area structure in the radial direction in accordance with the upper part, in a lower part. FIG. 2 is a partially enlarged perspective view showing a recording surface of the optical disc in the example of the information recording medium of the present invention.

As shown in the upper part in FIG. 1, an optical disc 100 is recordable in various recording methods, such as an optical magneto method and a phase change method, in which recording (writing) can be performed a plurality of times or only once. On a recording surface on a disc main body with a diameter of about 12 cm, as in a DVD, it is provided with a center hole 11 as the center, a lead-in area 101, a data area 102, and a lead-out area 103, from the inner circumference to the outer circumference. In each area, for example, tracks 10 such as a groove track and a land track are alternatively provided, spirally or concentrically, centered on the center hole 11. The groove track may be wobbled, and either or both of the tracks may have land pre-pits formed, for example.

More specifically, in the optical disc 100 in the example, as shown in FIG. 2, a recording type recording layer 107 which constitutes an information recording surface is laminated on the underside of a disc-shaped transparent substrate 106, and a reflective layer 108 is laminated on the underside of the recording layer 107. On the information recording surface which is formed of the surface of the recording layer 107, groove track GT and land track LT are alternately formed. Incidentally, in the recording and the reproduction of the optical disc 100, for example, as shown in FIG. 2, a laser beam LB is applied on the groove track GT through the transparent substrate 106. For example, in the recording, the laser beam LB is applied with a recording power, by which the recording is performed in the recording layer 107 in accordance with the record data. On the other hand, in the reproduction, the laser beam LB is applied with a reproduction laser power which is weaker than the recording laser power, by which the record data recorded in the recording layer 107 is read.

In the optical disc 100 in the example, the groove track GT may be wobbled with a constant amplitude and in a constant cycle (spatial frequency). In other words, the groove track GT may be wobbled, and the cycle of the wobble 109 may be set to a predetermined cycle.

On the land track LT, address pits referred to as land pre-pits PP which indicate pre-format address information may be formed. By the virtue of the two addressing (i.e. the wobble 109 and the pre-pits PP), it is possible to obtain information necessary for data recording, such as a recording address, generation of a recording clock, or disc rotation control during the recording. Incidentally, the pre-format address information may be recorded in advance by modulating the wobble 109 of the groove track GT in a predetermined modulation method such as frequency modulation and phase modulation.

Back in FIG. 1 again, as shown in the lower part in FIG. 1, with regard to the recording area in the radial direction of the optical disc 100, more specifically, it is provided with a power calibration area (hereinafter referred to as a “PCA” as occasion demands), a recording management area (hereinafter referred to as a “RMA” as occasion demands), the lead-in area 101, the data area 102, and the lead-out area 103, from the inner side to the outer side.

In the PCA (Power Calibration Area), the detection of a predetermined recording power, i.e. a process of calibrating the recording power (OPC (Optimum Power Control) process) is performed. The “predetermined recording power” in the example denotes, for example, such a recording power of the laser beam for recording record marks that can provide good reproduction quality for the record information including the record marks, immediately after the recording.

In the RMA (Recording Management Area), for example, RMD (Recording Management Data) can be recorded. Specifically, in the RMA, the RMD can be additionally recorded about 700 times. More specifically, the RMD may broadly include the following four types of various information: (i) identification number information, i.e. drive ID information (drive identification information), about an information recording/reproducing apparatus which has performed a recording operation on the optical disc 100; (ii) numerical information about a predetermined recording power detected as the calibration process by the information recording/reproducing apparatus specified by the drive ID (iii) disc status information which indicates an unrecorded status, a recording method such as an incremental recording method, a status in which a finalize process to be additionally-unrecordable, has been performed, or the like; and (iv) zone information for specifying a zone which is a recording logical unit.

The lead-in area 101 is provided with a control data zone (hereinafter referred to as a “CDZ” as occasion demands). In the CDZ, various information, such as the number of recording layers, the direction of the recording track, and a track pitch, in addition to the type, manufacturer, and manufacturing number of the optical disc, is pre-recorded by the laser beam or the like.

In the data area 102, the record information can be recorded. In the data area of the optical disc 100 in the example, the record information can be recorded by a recording unit of the zone described above.

Incidentally, the present invention is not particularly limited to the optical disc 100 having a plurality of recording areas as shown in FIG. 1. For example, the PCA is not necessarily located on the innermost circumference. For example, the PCA may be located in the lead-in area 101, the data area 102, the lead-out area 103 or the like. Alternatively, the PCA may be located between the lead-in area 101 and the data area 102, between the data area 102 and the lead-out area 103, on the outer side of the lead-out area 103, or the like. Moreover, the presence of the lead-in area 101 and the lead-out area 103 is also arbitrary. At least the two recording areas may be provided, which are the PCA and the data area 102 in which the record information is recorded. In addition, the PCA may be disposed in a unified manner, or in a plurality of divisions.

### (2) Basic Structure of Information Recording/Reproducing Apparatus in Example

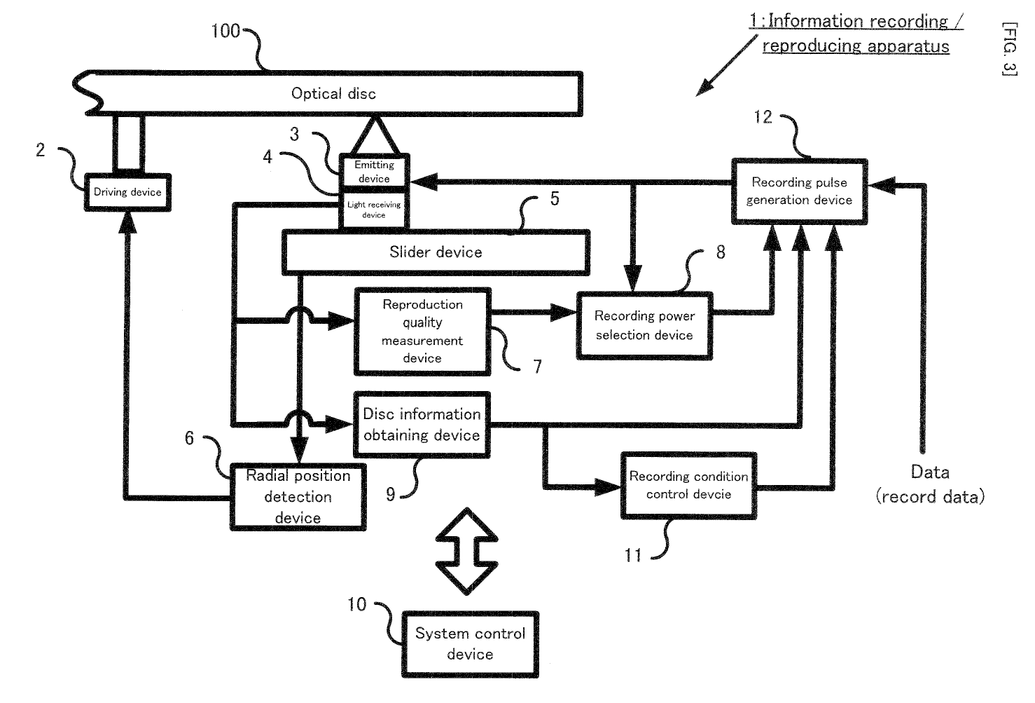

Next, with reference to FIG. 3, an explanation will be given on the basic structure of an information recording/reproducing apparatus in an example. FIG. 3 is a block diagram conceptually showing the basic structure of the information recording/reproducing apparatus in the example of the information recording apparatus of the present invention. Incidentally, the information recording/reproducing apparatus in the example includes the function of an information recording apparatus, the function of an information reproducing apparatus, or the function of an information recording/reproducing apparatus.

As shown in FIG. 3, an information recording/reproducing apparatus 1 in the example is provided with a drive device 2, an emitting device 3, a light receiving device 4, a slider device 5, a radial position detection device 6, a reproduction quality measurement device 7, a recording power selection device 8, a disc information obtaining device 9, a system control device 10 (hereinafter referred to as a “CPU 10” as occasion demands), a recording condition control device 11, and a recording pulse generation device 12.

The driving device 2 rotates the optical disc 100 on the basis of position information outputted from the radial position detection device 6 described later.

The emitting device 3 is provided mainly with a semiconductor laser, i.e. a LD (Laser Diode). The emitting device 3 is stored in a so-called optical pickup. Specifically, the emitting device 3 emits a laser beam to the optical disc to record or reproduce the data. Incidentally, one specific example of the “recording device” of the present invention is constructed of the emitting device 3.

The light receiving device 4 is provided mainly with a PD (Photo Detector). The light receiving device 4 receives reflected light from the optical disc 100.

The slider device 5, to which the optical pickup provided mainly with the emitting device 3 and the light receiving device 4 is mounted, displaces the optical pickup in the radial direction of the optical disc.

The radial position detection device 6 detects the radial position of the optical pickup and outputs the position information about the radial position to the drive device 2.

The reproduction quality measurement device 7 measures the reproduction quality of a recorded portion (i.e. a test-written portion) in the OPC (Optimum Power Control) process and outputs this measurement result to the recording power selection device 8 described later.

The recording power selection device 8 selects a recording power which provides the best reproduction quality, on the basis of a recording power for the OPC process and the reproduction quality outputted from the reproduction quality measurement device 7, and outputs it to the recording pulse generation device 12 described later. Here, the recording power for the OPC process in the example denotes, for example, such a recording power that is changed in stages in order to determine a predetermined recording power, immediately before the actual recording on the optical disc. The “predetermined recording power” in the example denotes, for example, the recording power of the laser beam for recording the record marks, which can provide the good reproduction quality of the record information including the record marks, immediately after the recording, as described above. In the OPC process, it is possible to measure each of a plurality of types of reproduction qualities for a plurality of portions recorded with a plurality of types of recording powers changed, and it is possible to determine the recording power which provides the best reproduction quality. Incidentally, the details of the OPC process will be described later. Moreover, one specific example of the “optimum light quantity determining device” of the present invention is constructed of the recording power selection device 8.

The disc information obtaining device 9 obtains information recorded in advance in the optical disc 100 (disc information about a recording strategy, a model number, a manufacturer, and the like). Specifically, in the operation process of the disc information obtaining device 9, firstly, disc attribute information unique to the optical disc, such as a product identification number, is obtained to specify, for example, a manufacturer and a maker. Then, the information recording/reproducing apparatus specifies a material from a correspondence table or the like on which manufacturers and materials for the recording layer of the optical disc are associated and which is stored in a memory device as a database. Thirdly, a mark length is determined in accordance with the specified material.

In particular, if the disc information obtaining device 9 obtains the information about the recording strategy, such as a standard pulse width which provides the optimum reproduction quality of the record information immediately after the recording, which is determined in advance by a disc manufacturer or the like, the disc information obtaining device 9 constitutes one specific example of the strategy information obtaining device of the present invention.

The system control device 10 (hereinafter referred to as the “CPU 10” as occasion demands) receives the data from the various constituents and performs a subsequent control operation, in order to control the operations of the entire information recording/reproducing apparatus 1. Then, on the basis of the data, the system control device 10 outputs a system command to each device provide for the information recording/reproducing apparatus 1, to thereby integrally control the entire information recording/reproducing apparatus 1. Normally, software for operating the system control device 10 is stored in, for example, a ROM or the like not illustrated.

The recording condition control device 11 outputs various control signals for changing recording conditions to the recording pulse generation device 12 descried later, on the basis of the obtained disc information or the like. Incidentally, one specific example of the “controlling device” of the present invention is constructed of the system controller 10 or the recording condition control device 11.

The recording pulse generation device 12 generates a recording pulse and outputs it to the emitting device 3, in each case of the “OPC process” and the “data recording”. More specifically, in the “OPC process”, the recording pulse generation device 12 generates a recording process pulse signal on the basis of the information outputted from the disc information obtaining device 9 and the recording power for the OPC process. On the other hand, in the “data recording”, the recording pulse generation device 12 generates the recording process pulse signal on the basis of the information outputted from the disc information obtaining device 9, the control signal outputted from the recording condition control device 11, and the information about the value of the recording power selected on the recording power selection device 8. Incidentally, one specific example of the “setting device” of the present invention is constructed of the recording pulse generation device 12.

Incidentally, in the aforementioned information recording/reproducing apparatus 1, necessary constituent in the example are extracted and illustrated, in order to explain the features of the present invention in an easy-to-understand manner. Thus, obviously, constituents other than the aforementioned ones may be also provided.

(2-2) Operation Principle

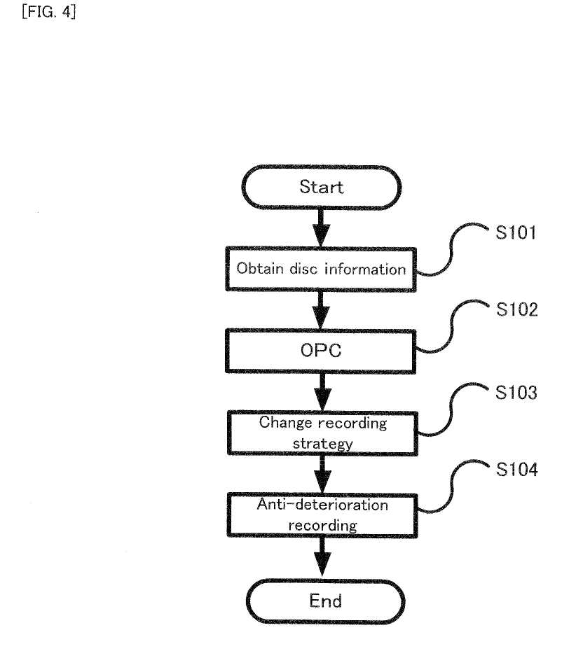

Next, with reference to FIG. 4 to FIG. 7, the operation principle of the information recording/reproducing apparatus 1 in the example will be described. FIG. 4 is a flowchart conceptually showing a recording operation flow of the information recording/reproducing apparatus in the example of the information recording apparatus of the present invention.

As shown in FIG. 4, firstly, the optical disc 100 is loaded on the information recording/reproducing apparatus. Under the control of the system control device 10 (hereinafter referred to as the “CPU 10” as occasion demands), a seek operation is performed by the optical pickup, and various recording management data is obtained which is necessary for the process of recording onto the optical disc 100. In addition, the disc information is obtained which indicates the type of the recording layer of the optical disc 100, the manufacturer, and the manufacturing number (step S101). Moreover, by reading the land pre-pits (LPP) in the lead-in area 104; a predetermined recording strategy (or pulse strategy) determined in advance is obtained. On the basis of the management data, by the control of the CPU 10; the data is recorded onto the optical disc 100 through an external input interface or the like, in accordance with an instruction from external input equipment or the like.

Then, on the basis of the various recording management data, the type of the recording layer of the optical disc 100, the manufacturer, and the manufacturing number which are obtained, the OPC (i.e. Optimum Power Control) process is performed in accordance with the optical disc 100; and the predetermined recording power (or predetermined laser power) in recording the data (or record information) is provisionally detected (step S102). Incidentally, the information about the recording strategy for recording test-writing data which is necessary to perform the OPC process, may be obtained from the optical disc. Alternatively, the information about the recording strategy may be stored in a memory device of the information recording/reproducing apparatus.

(2-2-1) OPC Process

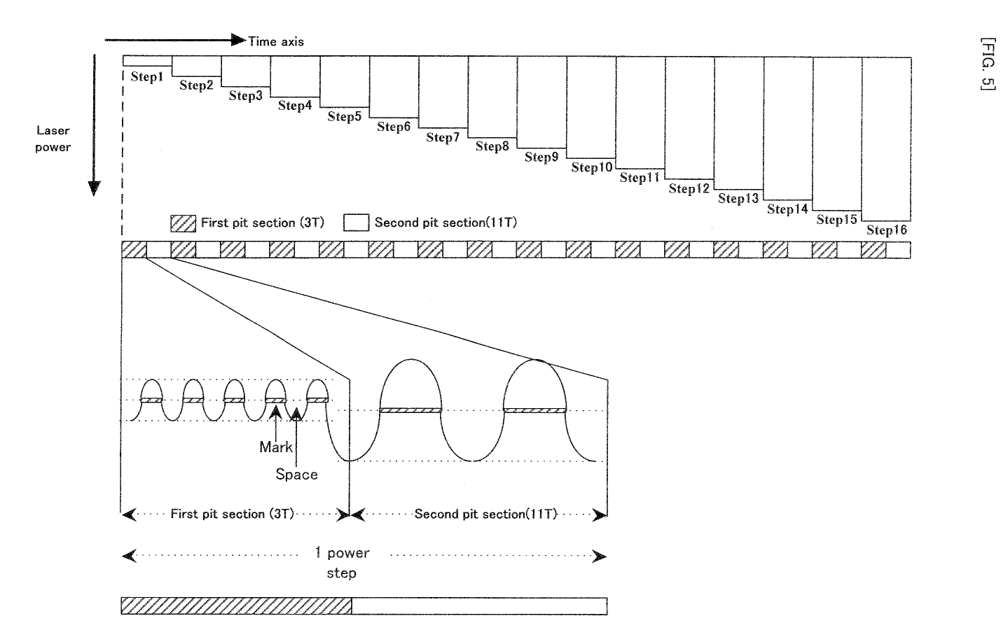

Here, the OPC process will be described with reference to FIG. 5. FIG. 5 is a schematic timing chart showing one OPC process, which is provided with 16 power steps, in the operation of the information recording/reproducing apparatus in the example of the information recording apparatus of the present invention. In the OPC, more specifically, for example, under the control of the CPU 10, the optical pickup which is one specific example of the “recording device” of the present invention is displaced to the aforementioned PCA (Power Control Area) on the optical disc 100. Then, in series and in stages, the laser power (or recording power) (e.g. mutually different 16-step power) is changed over, and a test signal such as an OPC pattern which is one specific example of the “test-writing information” of the present invention is recorded into the PCA.

Specifically, for example, a test signal such as a reference OPC pattern as shown in FIG. 5 which is generated by the recording pulse generation device 12 is recorded. As the test signal, for example, a 3T to 14T random pattern is listed as one example. The OPC pattern is prepared in accordance with the predetermined pulse strategy under the control of the CPU 10. FIG. 5 shows, as one specific example, an aspect of recording the OPC pattern including a first pit section in which a test signal in the 3T pattern of the random pattern is recorded and a second pit section in which an 11T pattern test signal is recorded, with each of the laser powers changed in stages. Of course, a different OPC pattern may be used with each of the laser powers changed in stages.

The aforementioned recording pulse generation device 12 drives the semiconductor laser in the optical pickup to change the laser power in series and in stages, by virtue of the OPC pattern.

Then, after the completion of the recording of the OPC pattern to the PCA, the recorded portion (i.e. the OPC pattern) in the PCA is reproduced, under the control of the CPU 10.

Then, the various types of reproduction quality are detected from a reproduced RF signal with each of the laser powers changed in stages.

The detection of the reproduction quality is performed, for example, in accordance with the number of the recording of the OPC pattern in one OPC process with each of the laser powers changed in stages.

As a result, it is possible to prepare correlated information which indicates a relation between the laser power changed in series and in stages and the various types of reproduction quality of the OPC pattern recorded with the laser power.

For example, the correlated information can be obtained by plotting asymmetry obtained by the reproduction of the OPC pattern and connecting the plots on an approximate curve, on a graph with the asymmetry on a vertical axis and the laser power changed in stages on a horizontal axis. The approximate curve can be prepared by using a mathematical or statistical method such as a least square method.

On the basis of the correlated information, the predetermined recording power is detected under the control of the CPU 10. In the OPC process, it is preferable to detect such a laser power that the asymmetry or a jitter value has an optimum or preferable value in the data immediately after the recording, as the predetermined laser power. For example, such a laser power that the asymmetry is zero may be detected as the predetermined laser power. Alternatively, such a laser power that the jitter value is minimal (or less than 8%) may be detected as the predetermined laser power. In other words, as described later, it is possible to judge whether or not the “reproduction quality” is good, on the basis of the condition that “the asymmetry is zero” and the condition that “the jitter value is less than 8%”. Of course, the present invention is not limited to this detecting method; such a laser power that can realize the reproduction quality allowed in the standard of the optical disc 100 on which the OPC pattern is recorded may be detected as the predetermined recording power.

Incidentally, the predetermined recording power may be detected by mathematically performing calculation or the like, in accordance with the relation between the laser power obtained by the reproduction of the OPC pattern and the various types of reproduction quality.

In particular, the aforementioned OPC process is not necessarily performed in the PCA. In other words, it may be performed in the data area or the like in tandem. Alternatively, it may be performed by using multiple laser beams simultaneously with the recording operation.

Back in FIG. 4 again, then, under the control of the CPU 10, one portion of the recording strategy is changed on the basis of the various recording management data, the type of the recording layer of the optical disc 100, the manufacturer, and the manufacturing number which are obtained (step S103).

(2-3) Method of Changing Recording Strategy

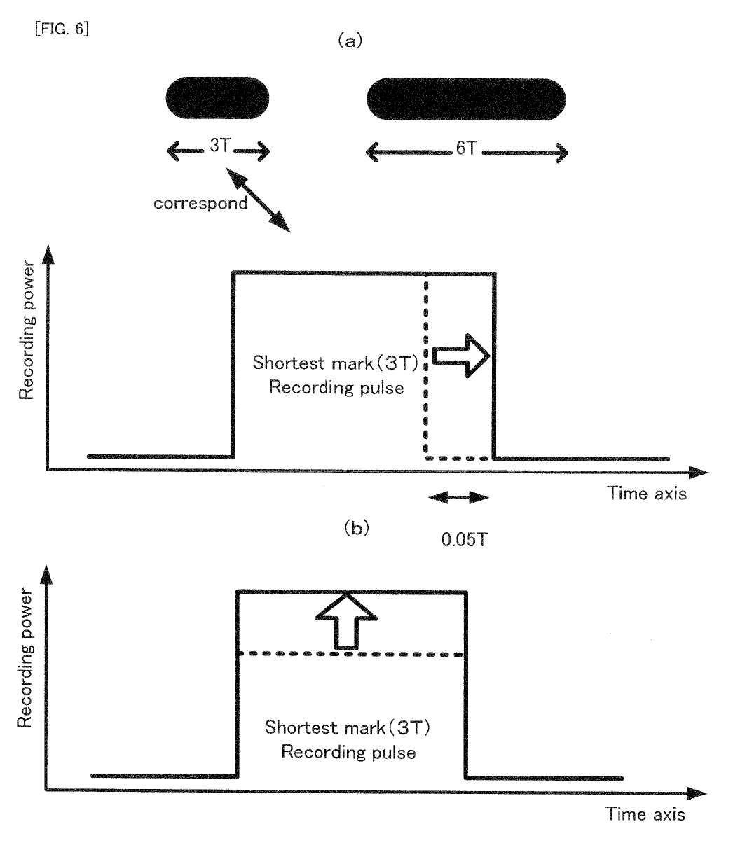

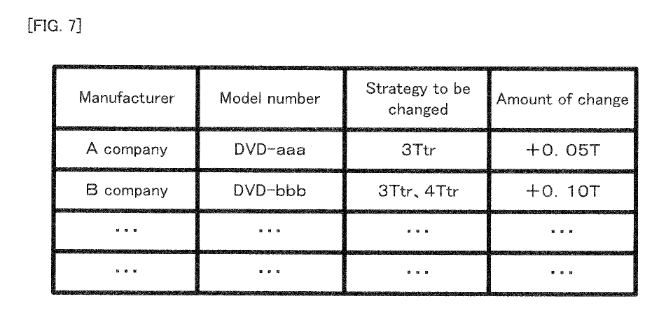

With reference to FIG. 6 and FIG. 7, one specific example of a method of changing the recording strategy in the example will be described. FIG. 6 are a schematic diagram schematically showing a change in pulse width of a pulse signal (FIG. 6(a)) and a schematic diagram schematically showing a change in recording power of the pulse signal (FIG. 6(b)), as a change in recording strategy in the example. FIG. 7 is a correspondence table to perform the change in recording strategy corresponding to the type or the like of the optical disc, as the change in recording strategy in the example. Incidentally, the recording pattern shown on the upper side in FIG. 6(a) conceptually indicates the record marks on the optical disc. Incidentally, the vertical axis in FIG. 6(a) and FIG. 6(b) indicates the recording power, and the horizontal axis indicates a time axis.

As one specific example of the method of changing the recording strategy in the example, as shown in FIG. 6(a); the pulse width of a pulse signal for recording the shortest record mark with a 3T mark length is increased by “0.05T” toward the rear side on the time axis in the predetermined recording strategy (or recording strategy pattern). Moreover, the pulse width of the pulse signal for recording the shortest record mark may be increased by “0.05T” toward the front side on the time axis, instead of toward the rear side on the time axis, in the predetermined recording strategy. Alternatively, the pulse width of the pulse signal for recording the shortest record mark may be increased by “0.025T” toward the rear side on the time axis and may be increased by “0.025T” toward the front side on the time axis in the predetermined recording strategy, to thereby increase it by “0.05T” in total on the rear side and the front side.

Moreover, alternatively, the pulse width of a pulse signal for recording the second shortest record mark with a 4T mark length may be increased by a predetermined amount in substantially the same manner as the above, in addition to or instead of the shortest record mark with a 3T mark length, in the predetermined strategy.

Moreover, alternatively, the pulse widths of pulse signals for recording record marks with 6T to 14T mark lengths, which are other than the shortest record mark with a 3T (or 4T) mark length and which are longer than the shortest record mark, may be reduced by a predetermined amount in substantially the same manner as the above, in the predetermined strategy, to thereby relatively increase the shortest record mark with a 3T mark length. As a result, the information recording apparatus can record the record information having the appropriate reproduction quality which is not deteriorated as time pass or with time, onto the information recording medium in accordance with a change occurring in the record marks with time, on the basis of the relative change in the mark length of the second shortest or shortest record mark.

Alternatively, as shown in FIG. 6(b), the recording power of the pulse signal for recording the shortest record mark with a 3T mark length may be changed, for example, to be in a predetermined range of 101% to 110% on the basis of the predetermined recording power, in the predetermined recording strategy. The “predetermined recording power” in the example denotes, for example, the recording power of the laser beam for recording the record marks which can provide the good reproduction quality of the record information including the record marks, immediately after the recording, as described above. Incidentally, the amount of change in the pulse width described above, or the predetermined range of the recording power described above can be obtained, individually and specifically, so as to obtain the desired reproduction quality, for example, experimentally, experientially, theoretically, or by simulations or the like. Incidentally, the shortest record mark with a 3T mark length may be relatively increased by reducing, by a predetermined amount, the recording power of the pulse signal for recording the record marks with 6T to 14T mark lengths which are other than the shortest record mark with a 3T (or 4T) mark length and which are longer than the shortest record mark, in the predetermined recording strategy.

In general, the information about the recording strategy for performing the recording process is recorded as the recording management data on the optical disc and is obtained from the optical disc. Alternatively, the information about the recording strategy for performing the recording process is stored in and obtained from the memory device of the information recording/reproducing apparatus.

In particular, the predetermined recording strategy which is obtained and which is general to perform the recording process, may be changed on the basis of the correspondence table corresponding to the type or the like of the optical disc, shown in FIG. 7. In other words, as shown in the first row, in other word, the first line of the correspondence table in FIG. 7, as for the optical disc on which the recording process is actually performed; if the “manufacturer” is “A company” and the “manufacturing model number” is “DVD-aaa”; the pulse width of the pulse signal for recording the shortest record mark with a 3T mark length, is increased by “0.05T” toward the rear side on the time axis in the predetermined recording strategy. Incidentally, “tr” in FIG. 7 indicates a direction toward the rear side on the time axis.

Alternatively, as shown the second row, in other word, the second line of the correspondence table in FIG. 7; if the “manufacturer” is “B company” and the “manufacturing model number” is “DVD-bbb”; the pulse width of the pulse signal for recording the shortest record mark with a 3T mark length, is increased by “0.10T” toward the rear side on the time axis in the predetermined recording strategy. In addition, the pulse width of the pulse signal for recording the second shortest record mark with a 4T mark length, is increased by “0.10T” toward the rear side on the time axis in the predetermined recording strategy. Incidentally, the correspondence table may be stored in and can be obtained from the memory device of the information recording/reproducing apparatus. Alternatively, it may be recorded as the recording management data on the optical disc, and it can be obtained from the optical disc.

Back in FIG. 4 again, under the control of the CPU 10, on the basis of the predetermined recording power detected in the OPC process described above and the recording strategy changed as described above, the data to be J actually recorded is recorded at a predetermined address position on the optical disc 100 (step S104).

### (3) Examine Operation and Effect in Example

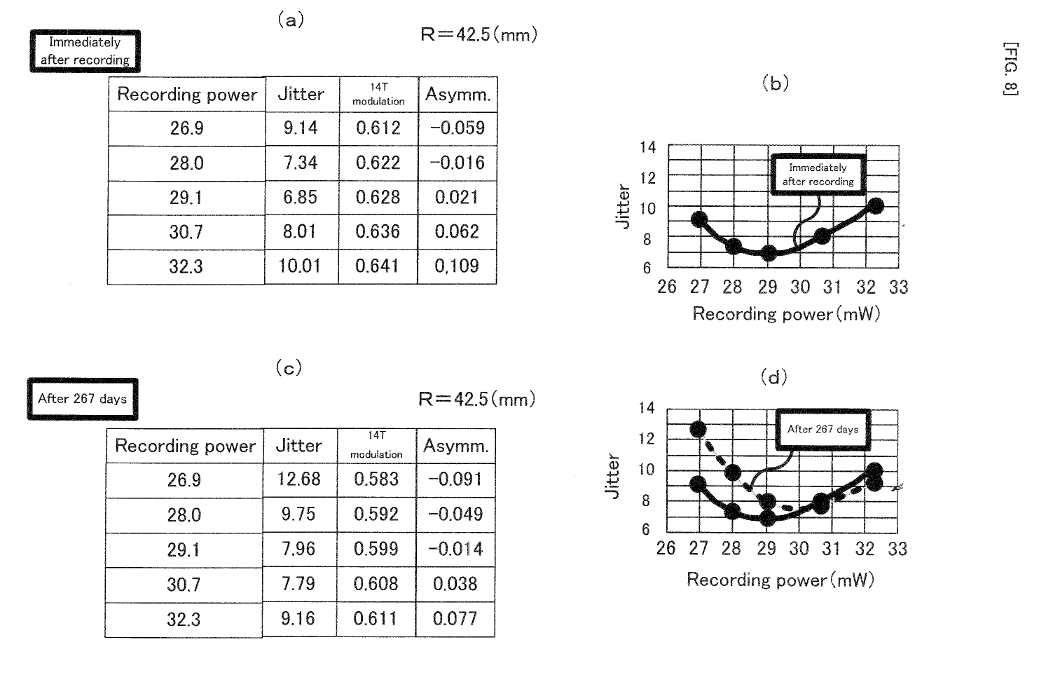

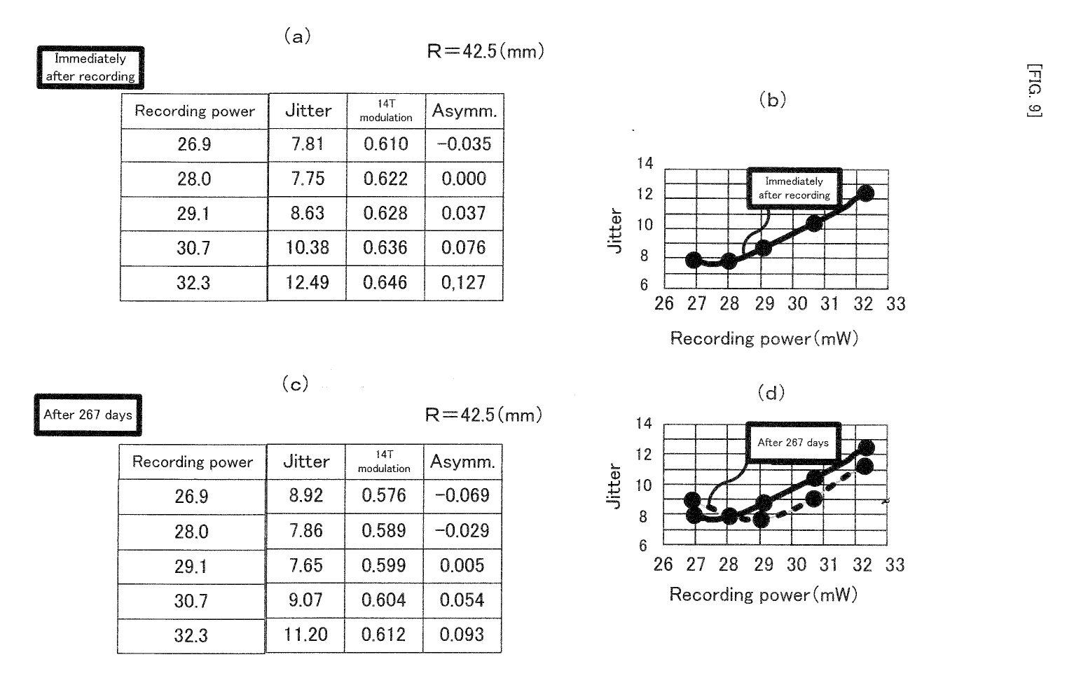

Next, with reference to FIG. 8 and FIG. 9, the operation and effect in the example will be examined. FIG. 8 are (i) a table and a graph (FIG. 8(a) and FIG. 8(b)) showing a correlation between the recording power and reproduction quality immediately after the recording of record marks recorded on an optical disc in a comparison example and (ii) a table and a graph (FIG. 8(c) and FIG. 8(d)) showing a correlation between the recording power and the reproduction quality after 267 days of the record marks or “two hundreds and sixty seven” days of the record marks. FIG. 9 are (i) a table and a graph (FIG. 9(a) and FIG. 9(b)) showing the correlation between the recording power and the reproduction quality immediately after the recording of record marks recorded on the optical disc in the example and (ii) a table and a graph (FIG. 9(c) and FIG. 9(d)) showing a correlation between the recording power and the reproduction quality after 267 days of the record marks. Specifically, FIG. 8 show a change in the jitter value, with the recording powers “immediately after the recording” and “267 days after the recording” being used as variables, in the case of recording with an 8×-speed or eight times speed on a recording type optical disc, such as a DVD-R, in the predetermined recording strategy.

As shown in FIG. 8(a) to FIG. 8(d), according to the research by the present inventors, it is found that; the reproduction quality of the record marks (or the record information held in the record marks) recorded on the optical disc in the comparison example, is remarkably deteriorated (changed) with time of 267 days. Specifically, as shown in FIG. 8(a) and FIG. 8(b), the predetermined recording power “immediately after the recording” is a recording power of “approximately 29(mW)” with the smallest jitter value measured by the reproduction of the record marks recorded. Moreover, various quality values, which indicate the reproduction quality measured in the recording area which is provided with or which has the record marks recorded with the predetermined recording power, are as follows. That is to say, the “jitter value” is “approximately 6.9%”, the “degree of modulation” is “approximately 63%”, and the asymmetry value is “approximately 2.1%”. Incidentally, as described above, if the jitter value is adopted as the quality value which indicates the reproduction quality, for example, it may be judged that the reproduction quality is good; in the case that the jitter value is less than about 8% which indicates a standard value.

With respect to the recording area which is provided with or which has the record marks which are recorded with the predetermined recording power, the various quality values measured again after 267 days are as follows. That is to say, the “jitter value” is “approximately 8.0%”, the “degree of modulation” is “approximately 60%”, and the asymmetry value is “approximately −1.4%”. As described above, since in the change in the reproduction quality, the degree of modulation is reduced from “approximately 63%” to “approximately 60%”, it is possible to estimate that; this phenomenon is caused by a reduction in the mark length of the record marks as time pass or with time. In addition, since the asymmetry value is reduced from “approximately 2.1%” to “approximately −1.4%”, it is possible to estimate that; the deterioration in the reproduction quality has a remarkably large effect on the record mark with a relatively short mark length.

As a result, a balance in mark length ratio is deteriorated (or lost), for example, between the shortest record mark with a 3T mark length (wherein “T” denotes a reference clock cycle) and the longest record mark with a 14T mark length. The jitter value is increased from “approximately 6.9%” to “approximately 8.0%”, owing to this, it is also seen that the deterioration of the reproduction quality has been occurred.

Specifically, in the information recording/reproducing apparatus such as a DVD writer on the market, in order to respond to various environmental conditions such as external temperature, the detection of (or search for) the predetermined recording power, i.e. a process of calibrating the recording power (i.e. OPC (Optimum Power Control) process), is performed immediately before the record information is recorded. The predetermined recording power detected in this manner, has a predetermined error, centered on a certain recording power, so that the recording power actually applied or irradiated, has an error in a certain degree of range. Here, in view of the error range in the predetermined recording power; it is assumed that there is an error range of about “±1 (mW)” with respect to “approximately 29 (mW)” which is a value of the predetermined recording power, and in other words, it is assumed that the recording power varies by “approximately ±1 (mW)”. In this case, the recording power actually applied is in an error range of “approximately 28 (mW)” to “approximately 30 (mW)”; and the jitter value “immediately after the recording” in the error range of this recording power is “approximately 7.4%”, if the deterioration in the reproduction quality, is maximal, as shown in FIG. 8(a) and FIG. 8(b). However, as shown in FIG. 8(c) and FIG. 8(d), if “after 267 days”, the jitter value may be likely deteriorated up to “approximately 9.8%” due to the deterioration in the reproduction quality.

In contrast, according to the example, on the basis of the estimation that the aforementioned deterioration in the reproduction quality as time pass, in other words, the aforementioned deterioration in the reproduction quality with time, has a remarkably large effect on the record mark with a relatively short mark length; the recording conditions in recording the record mark with a relatively short mark length, are intentionally changed. Specifically, as described above, for example, the pulse width of the pulse signal for recording the shortest record mark with a 3T mark length, is increased by “0.05T” toward the rear side on the time axis, in the predetermined recording strategy (or recording strategy pattern). Moreover, the pulse width of the pulse signal for recording the shortest record mark, may be increased by “0.05T” toward the front side on the time axis instead of toward the rear side on the time axis, in the predetermined recording strategy. Alternatively, the pulse width of the pulse signal for recording the shortest record mark, may be increased by “0.025T” toward the rear side on the time axis and may be increased by “0.025T” toward the front side on the time axis in the predetermined recording strategy, to thereby increase it by “0.05T” in total on the rear side and the front side.

As a result, it is possible to prevent the deterioration in the reproduction quality as time pass, more effectively. Specifically, as shown in FIG. 9(a) to FIG. 9(d), according to the research by the present inventors; it is found that it is possible to more effectively prevent the deterioration with time of 267 days in the reproduction quality of the record marks (or the record information held in the record marks) recorded on the optical disc in the example. Specifically, in the research result in the example shown in FIG. 9, the recording conditions except the increased pulse width are substantially the same as the recording conditions in the comparison example shown in FIG. 8. Incidentally, FIG. 9 show the change in the jitter value, with the recording powers “immediately after the recording” and “267 days after the recording” being used as variables, in the case of recording with an 8×-speed on a recording type optical disc, such as a DVD-R, in a strategy obtained by changing the predetermined recording strategy.

Specifically, as shown in FIG. 9(a) and FIG. 9(b), as described above, if the pulse width is increased by “0.05T” in the predetermined recording strategy; various quality values, which indicate the reproduction quality measured in the recording area which is provided with or which has the record marks recorded with a recording power of “approximately 29 (mW)”, are as follows. That is to say, the “jitter value” is “approximately 8.6%”, the “degree of modulation” is “approximately 63%”, and the asymmetry value is “approximately 3.7%”.

With respect to the recording area which is provided with or which has the record marks recorded with the predetermined recording power; the various quality values measured again after 267 days are as follows. That is to say, the “jitter value” is “approximately 7.7%”, the “degree of modulation” is “approximately 60%”, and the asymmetry value is “approximately 0.5%”. As described above, in the recording area immediately after the recording; a balance in mark length ratio is deteriorated (or lost), for example, between the shortest record mark with a 3T mark length and the other record marks. On the basis of the jitter value, the reproduction quality is considered to be not good.

However, it is found that the deterioration in the reproduction quality with time “after 267 days” is effectively prevented; that the balance in mark length ratio is improved, for example, between the shortest record mark with a 3T mark length and the other record marks; and that the jitter value is remarkably improved from “approximately 8.6%” to “approximately 7.7%”. In view of the error range of the recording power actually applied or irradiated; even if the deterioration in the reproduction quality is maximal, the jitter value “after 267 days” is “approximately 8.3%” in the record marks which are recorded with the recording power of “approximately 28 (mW)” to “approximately 30 (mW)”. It is found that the reproduction quality is remarkably improved in the example of the present invention, compared to the result of the deterioration in the jitter value “approximately 9.8%” in the comparison example in which the recording strategy is not changed from the standard recording strategy.

From the aforementioned results, by elongating (or increasing) the pulse width of the pulse signal for recording the shortest record mark from a reference width (or first predetermined width) which is a reference, by a predetermined ratio; it can be confirmed that the deterioration in the reproduction quality as time pass, in other words, the deterioration in the reproduction quality with time, can be prevented more effectively.

Moreover, in particular, the pulse width of the pulse signal for recording the record mark with a 4T mark length in addition to the shortest record mark with a 3T mark length, may be increased in substantially the same manner. As a result, it is possible to prevent the deterioration in the reproduction quality as time pass, in other words, the deterioration in the reproduction quality with time, more remarkably effectively.

Moreover, as shown in FIG. 6(b) described above, the recording power of the pulse signal for recording the shortest record mark with a 3T mark length, may be changed to be in a predetermined range on the basis of the predetermined recording power, in the predetermined recording strategy.

As described above, it is also possible to prevent the deterioration in the reproduction quality as time pass or the deterioration in the reproduction quality with time, more effectively; by increasing the recording power of the pulse signal for recording the shortest record mark by a predetermined ratio from the predetermined recording power (or the power that provides the good reproduction quality immediately after the recording), in addition to changing the pulse width of the record marks.

Moreover, when a difference between the jitter value immediately after the recording and the jitter value after 267 days was obtained for each recording power on the basis of the experimental result shown in FIG. 8(a) to FIG. 8(d); it was confirmed that the difference is the smallest if the recording power is 30.3 (mW). Specifically, the jitter value “immediately after the recording” and the jitter value “267 days after the recording” are both about 7.6%. Considering that the recording power of “approximately 30.3 (mW)” has the variance of “approximately ±1 (mW)”; the jitter value “267 days after the recording” is about 8.3%, if the reproduction quality is not good. Therefore, in FIG. 8(b), it is possible to guarantee substantially the same reproduction quality as that immediately after the recording, even “267 days after the recording”; by intentionally performing the recording with the recording power (“30.3 (mW)”) which is greater than the predetermined recording power of “approximately 29.0 (mW)” which provides the good reproduction quality immediately after the recording.

Consequently, it is possible to prevent the deterioration in the reproduction quality as time pass or the deterioration in the reproduction quality with time, more effectively; by increasing the recording power of the pulse signal for recording the record mark by the predetermined ratio from the predetermined recording power (or the power that provides the good reproduction quality immediately after the recording).

### (4) Another Specific Example of Method of Changing Recording Strategy (Part 1)

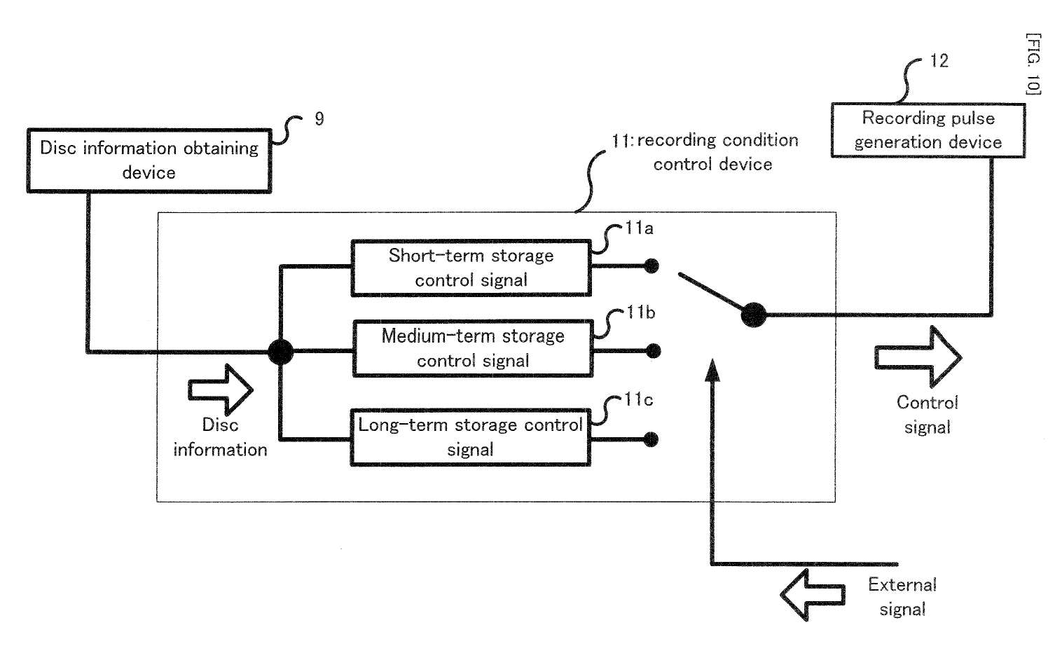

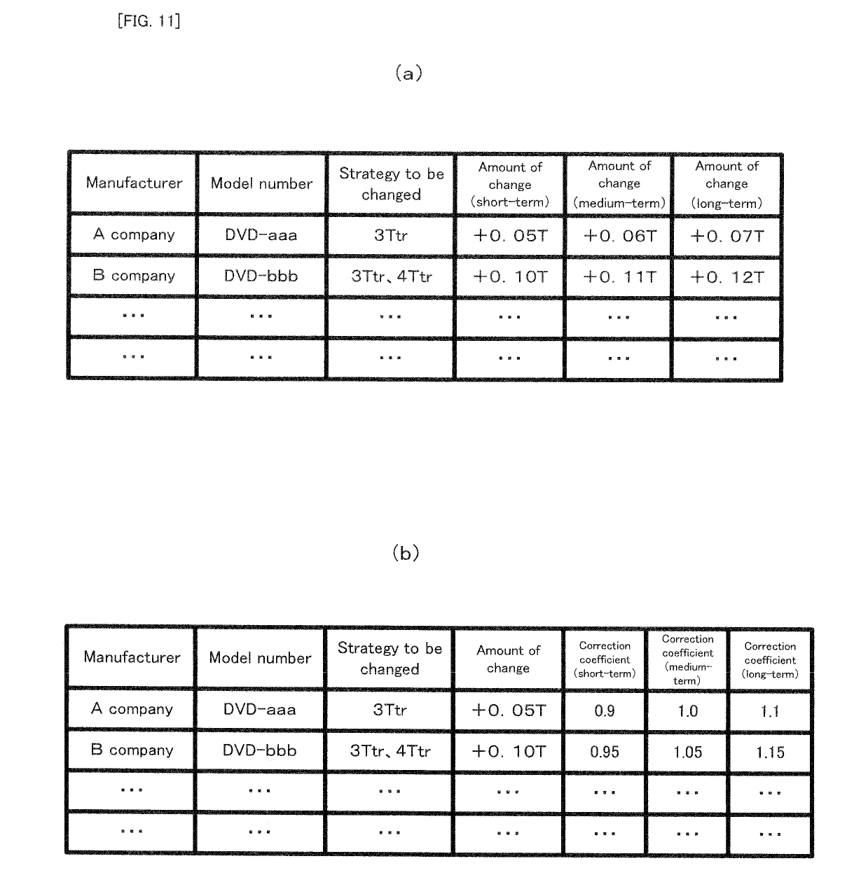

Next, with reference to FIG. 10 and FIG. 11, another specific example (part 1) of the method of changing the recording strategy in the example will be described. FIG. 10 is a block diagram schematically showing the structure of a recording condition control device which performs the change in recording strategy in the example in accordance with a storage period of the optical disc. FIG. 11 is a correspondence table to perform the change in recording strategy corresponding to the storage period of the optical disc, in addition to the type or the like of the optical disc, as the change in recording strategy in the example.

As another specific example of the method of changing the recording strategy in the example, as shown in FIG. 10; the aforementioned recording condition control device 11 may output the control signals for changing the recording conditions, such as the recording strategy and the recording power, to the recording pulse generation device 12, on the basis of the storage period of the optical disc, in addition to the various recording management data and the disc information; after the various recording management data and the disc information from the optical disc are outputted from the disc information obtaining device 9. Specifically, the recording condition control device 11 may output a short-term storage control signal 11a for changing the recording conditions to short-term storage recording conditions according to a short-term storage period, to the recording pulse generation device 12, in order to appropriately guarantee the reproduction quality of the record marks recorded on the optical disc for the short-term storage period, such as one year. Alternatively, the recording condition control device 11 may output a medium-term storage control signal 11b for changing the recording conditions to medium-term storage recording conditions according to a medium-term storage period, to the recording pulse generation device 12; in order to appropriately guarantee the reproduction quality of the record marks recorded on the optical disc for the medium-term storage period, such as 2 to 10 years. Alternatively, the recording condition control device 11 may output a long-term storage control signal 11c for changing the recording conditions to long-term storage recording conditions according to a long-term storage period, to the recording pulse generation device 12; in order to appropriately guarantee the reproduction quality of the record marks recorded on the optical disc for the long-term storage period, such as more than 10 years. In particular, the length of the storage period may be determined on the basis of the type and characteristics of the record information held by the record marks. Specifically, if the record information held by the record marks is about medical records, securities, official certificates, and the like; the recording condition control device 11 may automatically or manually output the long-term storage control signal 11c for changing the recording conditions to the long-term storage recording conditions, to the recording pulse generation device 12. Alternatively, if the record information held by the record marks is about movie contents and the like, the recording condition control device 11 may automatically or manually output the short-term storage control signal 11a for changing the recording conditions to the short-term storage recording conditions, to the recording pulse generation device 12, in accordance with the duration of copyright. Incidentally, the short-term storage control signal 11a, the medium-term storage control signal 11b, and the long-term storage control signal 11c may be outputted to the recording pulse generation device 12 together with an external signal for constituting a general recording pulse.

In particular, by recording the three types of record marks (or record information or data) in the three types of recording conditions corresponding to the three types of storage periods; the record marks whose reproduction quality is guaranteed, may be always on the optical disc without depending on the length of the storage period.

Alternatively, specifically, the predetermined recording strategy which is obtained and which is general to perform the recording process, may be changed on the basis of the correspondence table corresponding to the storage period of the optical disc in addition to the type or the like of the optical disc, as shown in FIG. 11(a). In other words, as shown in the first row of the correspondence table in FIG. 11(a), as for the optical disc on which the recording process is actually performed, if the “manufacturer” is “A company” and the “manufacturing model number (or manufacturing number)” is “DVD-aaa”; the pulse width of the pulse signal for recording the shortest record mark with a 3T mark length, may be increased by “0.05T” toward the rear side on the time axis in the predetermined recording strategy; in order to appropriately guarantee the reproduction quality of the record marks recorded on the optical disc made by the “A company” for the short-term storage period, such as one year. Alternatively, the pulse width of the pulse signal for recording the shortest record mark with a 3T mark length, may be increased by “0.06T” toward the rear side on the time axis in the predetermined recording strategy; in order to appropriately guarantee the reproduction quality of the record marks recorded on the optical disc for the medium-term storage period, such as 2 to 10 years. Alternatively, the pulse width of the pulse signal for recording the shortest record mark with a 3T mark length may be increased by “0.07T” toward the rear side on the time axis in the predetermined recording strategy; in order to appropriately guarantee the reproduction quality of the record marks recorded on the optical disc for the long-term storage period, such as more than 10 years.

On the other hand, as shown in the second row of the correspondence table in FIG. 11(a), as for the optical disc on which the recording process is actually performed; if the “manufacturer” is “B company” and the “manufacturing model number (manufacturing number)” is “DVD-bbb”, the pulse width of the pulse signal for recording the shortest record mark with a 3T mark length, may be increased by “0.10T” toward the rear side on the time axis in the predetermined recording strategy; in order to appropriately guarantee the reproduction quality of the record marks recorded on the optical disc made by the “B company” for the short-term storage period, such as one year, substantially as in the optical disc from the “A company”. In addition, the pulse width of the pulse signal for recording the second shortest record mark with a 4T mark length, may be increased by “0.10T” toward the rear side on the time axis. Alternatively, the pulse width of the pulse signal for recording the shortest record mark with a 3T mark length, may be increased by “0.11T” toward the rear side on the time axis in the predetermined recording strategy; in order to appropriately guarantee the reproduction quality of the record marks recorded on the optical disc for the medium-term storage period, such as 2 to 10 years. In addition, the pulse width of the pulse signal for recording the second shortest record mark with a 4T mark length, may be increased by “0.11T” toward the rear side on the time axis. Moreover, alternatively, the pulse width of the pulse signal for recording the shortest record mark with a 3T mark length, may be increased by “0.12T” toward the rear side on the time axis in the predetermined recording strategy; in order to appropriately guarantee the reproduction quality of the record marks recorded on the optical disc for the long-term storage period, such as more than 10 years. In addition, the pulse width of the pulse signal for recording the second shortest record mark with a 4T mark length may be increased by “0.12T” toward the rear side on the time axis.

Incidentally, the amount of change in the pulse width described above, can be obtained, individually and specifically, so as to obtain the desired reproduction quality, for example, experimentally, experientially, theoretically, or by simulations or the like. Moreover, as shown in FIG. 11(b), the pulse width to be changed, may be defined by multiplying the amount of change which is a reference, by a correction coefficient. Moreover, the correspondence table may be stored in and can be obtained from the memory device of the information recording/reproducing apparatus. Alternatively, it may be recorded as the recording management data on the optical disc, and it can be obtained from the optical disc. Moreover, the recording power of the pulse signal for recording the various record marks, may be changed on the basis of the storage period of the optical disc, in addition to the type or the like of the optical disc, with the predetermined recording power used as a reference, in the predetermined recording strategy.

### (5) Another Specific Example of Operation Principle (Part 2)

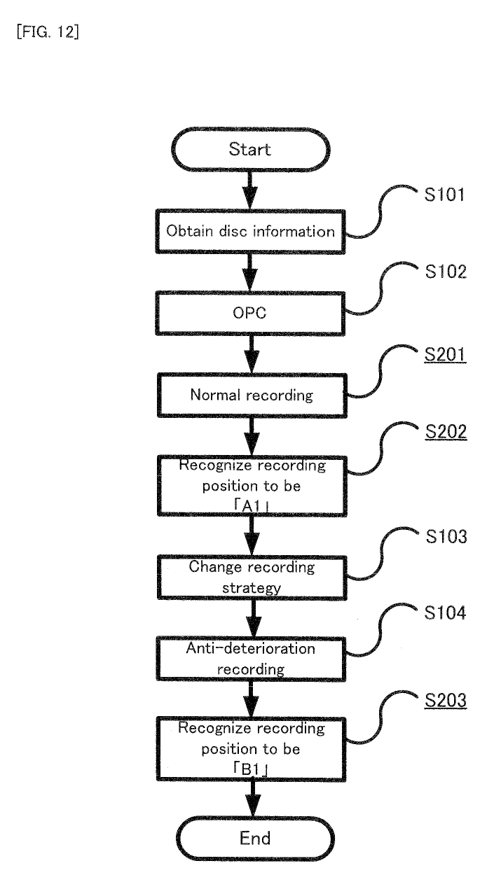

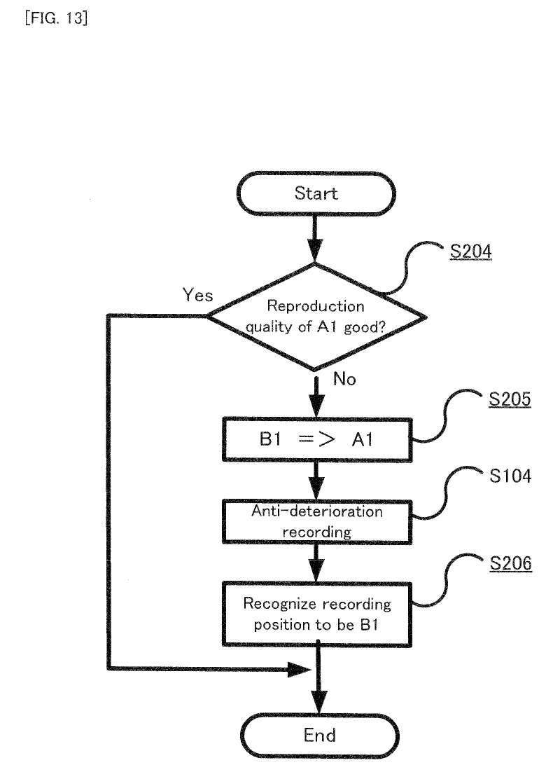

Next, with reference to FIG. 12 and FIG. 13, another specific example (part 2) of the operation principle of the information recording/reproducing apparatus 1 in the example will be described. FIG. 12 is one flowchart conceptually explaining another recording operation flow of the information recording/reproducing apparatus in the example of the information recording apparatus of the present invention. FIG. 13 is another flowchart conceptually explaining another recording operation flow of the information recording/reproducing apparatus in the example of the information recording apparatus of the present invention. Incidentally, substantially the same processes as those in FIG. 4 described above carry the same step numbers, and their explanation are omitted as occasion demands.

In particular, in another specific example of the operation principle of the information recording/reproducing apparatus 1 in the example, both (i) “normal recording” of the data to be recorded and (ii) recording with the changed recording strategy of the data to be recorded (i.e. anti-deterioration recording) are performed simultaneously; and the reproduction quality is verified and observed regularly in the recording area in which the normal recording is performed. If the reproduction quality is deteriorated in the recording area in which the normal recording is performed; the recording with the changed recording strategy of the data to be recorded (i.e. anti-deterioration recording) is performed again. Hereinafter, this recording operation will be described in accordance with its process steps.

(5-1) Normal Recording and Recording Process Based On Changed Recording Strategy

Firstly, after the aforementioned step S101 and step S102, the normal recording process is performed on the basis of the predetermined recording power detected in the aforementioned OPC process; and the data to be actually recorded is recorded at a predetermined address position “A1” under the control of the CPU 10 (step S201).

Then, under the control of the CPU 10, the normal recording process is performed, and the predetermined address position on the optical disc 100 at which the data is actually recorded, is recognized as the position “A1” (step S202).

Then, as described above, under the control of the CPU 10, one portion of the recording strategy is changed on the basis of the various recording management data, the type of the recording layer of the optical disc 100, the manufacturer, and the manufacturing number which are obtained (the step S103).

Then, as described above, under the control of the CPU 10, on the basis of the predetermined recording power detected in the OPC process described above and the recording strategy changed as described above; the data to be actually recorded is recorded at a predetermined address position “B1” on the optical disc 100 (the step S104).

Then, under the control of the CPU 10, the predetermined address position on the optical disc 100 at which the data is actually recorded is recognized as the position “B1”, in the recording process based on the changed recording strategy (step S203).

(5-2) Recording Process after Certain Time

Then, as shown in FIG. 13, under the control of the CPU 10, it is judged whether or not the reproduction quality of the data recorded at the position “A1” is good after a certain time, such as one year (step S204). Incidentally, in the judgment about the reproduction quality, as described above, it may be judged that the reproduction quality is good, for example; if the jitter value is less than about 8% which indicates a standard value, when the jitter value is adopted as the quality value.

Here, if it is judged that the reproduction quality of the data recorded at the position “A1” is not good (the step S204: No), the data recorded at the position “B1” is used instead of the data recorded at the position “A1”, under the control of the CPU 10 (step S205).

Then, under the control of the CPU 10, on the basis of the predetermined recording power detected in the OPC process described above and the recording strategy changed as described above; the data originally recorded at the position “A1” is recorded again at another address position on the optical disc 100 (the step S104).

Then, under the control of the CPU 10, the other address position on the optical disc 100 at which the data is actually recorded, is recognized as the position “B1”, in the recording process based on the changed recording strategy (step S206). Incidentally, the recording power of the pulse signal for recording the various record marks, may be changed on the basis of the storage period of the optical disc, in addition to the type or the like of the optical disc, with the predetermined recording power as a reference, in the predetermined recording strategy.

As described above, the data recorded by the recording process based on the changed recording strategy, is made always redundantly present and is managed, by which it is possible to effectively prevent that the data cannot be read and the data is lost, due to the deterioration in the reproduction quality with time or as time pass.

### (6) Another Specific Example of Operation Principle (Part 3)

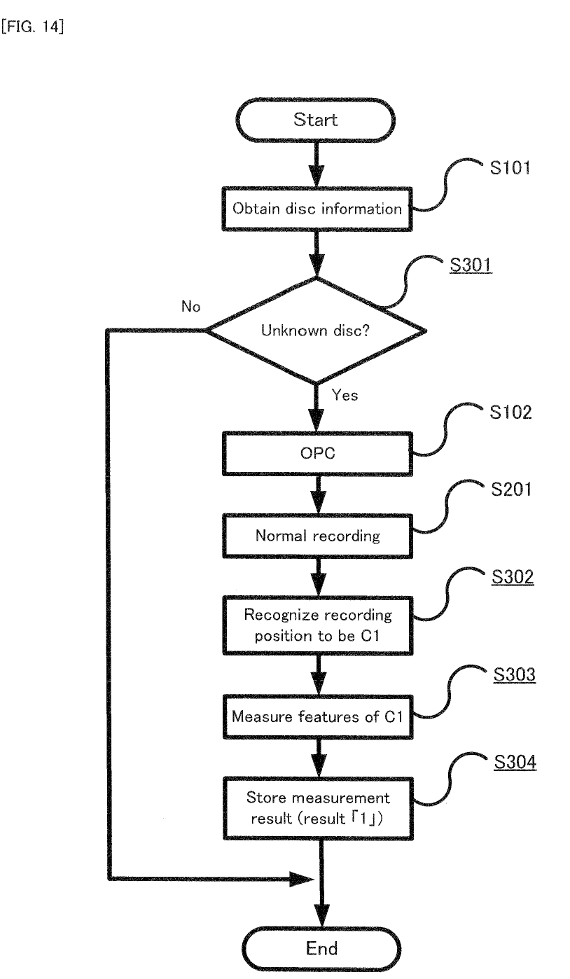

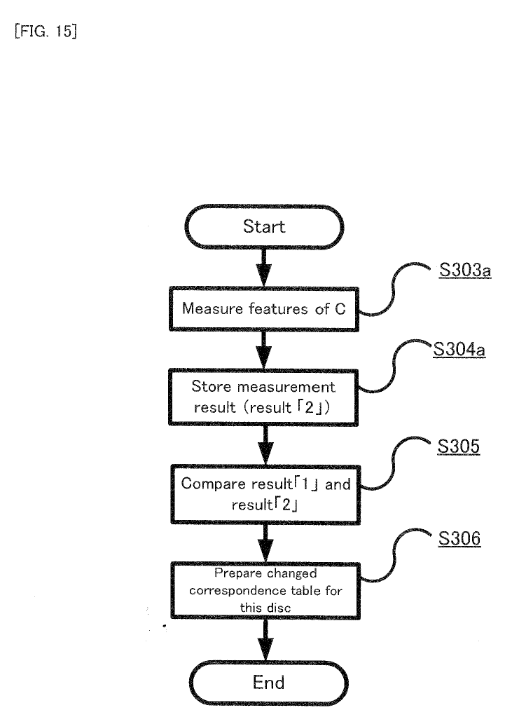

Next, with reference to FIG. 14 and FIG. 15, another specific example (part 3) of the operation principle of the information recording/reproducing apparatus 1 in the example will be described. FIG. 14 is one flowchart conceptually explaining another recording operation flow of the information recording/reproducing apparatus in the example of the information recording apparatus of the present invention. FIG. 15 is another flowchart conceptually explaining another recording operation flow of the information recording/reproducing apparatus in the example of the information recording apparatus of the present invention. Incidentally, substantially the same processes as those in FIG. 4, FIG. 12, or FIG. 13 described above carry the same step numbers, and their explanation are omitted as occasion demands.

In particular, in another specific example of the operation principle of the information recording/reproducing apparatus 1 in the example, the correspondence table about the amount of change in the recording power and/or the pulse width described above, is preferably stored in the memory device of the information recording/reproducing apparatus, from the viewpoint of a quick and appropriate change in the recording conditions. Thus, it might be possible to newly add information about the amount of change in the recording power and the pulse width for the optical disc, to the optical disc that is not described on the correspondence table, namely, the optical disc in which the amount of change in the recording power and the pulse width to effectively prevent the deterioration in the reproduction quality with time is unknown. Hereinafter, this recording operation will be described in accordance with its process steps.

(6-1) Recording Process on Unknown Optical Disc

Firstly, after the obtainment of the disc information in the aforementioned step S101; it is judged whether or not the loaded optical disc is the optical disc that is not described on the correspondence table, namely, the optical disc in which the amount of change in the recording power and the pulse width to effectively prevent the deterioration in the reproduction quality with time is unknown (step S301). Here, if it is judged that the loaded optical disc is the optical disc that is not described on the correspondence table, namely, the optical disc in which the amount of change is unknown (the step S301: Yes), the normal recording process is performed on the basis of the predetermined recording power detected in the OPC process in the aforementioned step 102, and the data to be actually recorded is recorded at a predetermined address position “C1” (the step S201).

Then, under the control of the CPU 10, the normal recording process is performed, and the predetermined address position on the optical disc 100 at which the data is actually recorded is recognized as the position “C1” (step S302).

Then, under the control of the CPU 10, the reproduction quality such as the jitter value and the asymmetry is measured for the data recorded at the position “C1” (step S303).

Then, under the control of the CPU 10, information about a measurement result of the reproduction quality for the data recorded at the position “C1”, is stored as a result “1” into the memory device of the information recording/reproducing apparatus (step S304). Incidentally, the information about the measurement result of the reproduction quality may be shown in a form of a graph which indicates values of the various types of reproduction quality with the recording power and time used as variables, as shown in FIG. 9 described above; or it may be shown in another aspect from which a correlation among the recording conditions, time, and the reproduction quality can be recognized.

On the other hand, as a result of the judgment in the step S301 described above, if it is judged that the loaded optical disc is the optical disc that is described on the correspondence table and in which the amount of change is known (the step S301: No), as described above, under the control of the CPU 10; the data to be actually recorded is recorded at a predetermined address position on the optical disc, on the basis of the predetermined recording power detected in the OPC process described above and the recording strategy changed as described above (the step S104).

(6-2) Recording Process after Certain Time

Then, as shown in FIG. 15, under the control of the CPU 10, the reproduction quality such as the jitter value and the asymmetry for the data recorded on the position “C1” is measured again after a certain time such as one year (step S303a).

Then, under the control of the CPU 10, information about a measurement result of the reproduction quality for the data recorded at the position “C1”, is stored as a result “2” into the memory device of the information recording/reproducing apparatus (step S304a).

Then, under the control of the CPU 10, the result “1” and the result “2” which are stored in the memory device of the information recording/reproducing apparatus are compared; and the amount of change in the recording power and the pulse width to effectively prevent the deterioration in the reproduction quality for the unknown optical disc, is recognized, on the basis of a difference between the values which indicate the reproduction quality (step S305).

Then, under the control of the CPU 10, the amount of change in the recording power and the pulse width recognized in this manner, is added to the correspondence table (step S306). Incidentally, the correspondence table to which the information about the amount of change is newly added, may be stored again into the memory device of the information recording/reproducing apparatus. Alternatively, it may be recorded on the optical disc as the recording management data in an additionally recordable or rewritable manner.

Consequently, by virtue of the information recording/reproducing apparatus in the example, even in the optical disc that is not described on the correspondence table, namely, the optical disc in which the amount of change in the recording conditions is unknown; it is possible to provide the known amount of change in the recording power and the pulse width to effectively prevent the deterioration in the reproduction quality, before the optical disc is loaded on the information recording/reproducing apparatus.

Moreover, in the aforementioned examples, as one example of the information recording medium, the optical disc aimed at the long-term storage period was described. Moreover, as one example of the information recording apparatus, the information recording/reproducing apparatus such as a recorder for the optical disc aimed at the long-term storage period was described. The present invention, however, is not limited to the optical disc and the recorder thereof, and can be applied to other various information recording media which support high-density recording or a high transfer rate, and recorders thereof.

The present invention is not limited to the aforementioned embodiment, but various changes may be made, if desired, without departing from the essence or spirit of the invention which can be read from the claims and the entire specification. An information recording apparatus and method, and a computer program, all of which involve such changes, are also intended to be within the technical scope of the present invention.

### INDUSTRIAL APPLICABILITY

The information recording apparatus according to the present invention can be applied to a recorder or the like for an optical disc aimed at a long-term storage period. Moreover, it can be also applied to a recorder or the like for various information recording media which support high-density recording or a high transfer rate.

1-21. (canceled)

22. An information recording apparatus comprising:
a recording device for recording record information by applying a laser beam from a light source to an information recording medium and thus recording record marks with a plurality of types of lengths;
a setting device for setting recording conditions in accordance with a change occurring the record marks with time; and
a controlling device for controlling said recording device to record the record marks on the basis of the set recording conditions.

23. The information recording apparatus according to claim 22, wherein said setting device sets the recording conditions to change a mark length of the shortest or second shortest record mark, of the plurality of types of lengths.

24. The information recording apparatus according to claim 23, wherein said setting device sets the recording conditions to change the mark length by changing a pulse width of a pulse signal which drives the light source.

25. The information recording apparatus according to claim 23, wherein said setting device sets the recording conditions to change the mark length by changing a recording power or light quantity of the laser beam applied from the light source.

26. The information recording apparatus according to claim 22, further comprising an optimum light quantity determining device for determining an optimum recording power or light quantity for the information recording medium by an OPC (Optimum Power Control) process,
said setting device setting the recording conditions to apply the laser beam from the light source with a recording power or light quantity corresponding to 101% to 110% of the determined optimum recording power or light quantity.

27. The information recording apparatus according to claim 23, wherein said setting device sets the recording conditions to change the mark length in accordance with a material for a recording layer of the information recording medium.

28. The information recording apparatus according to claim 27, further comprising:
a disc information obtaining device for obtaining disc attribute information about the information recording medium; and
a specifying device for specifying the material for the recording layer of the information recording medium on the basis of the disc attribute information.

29. The information recording apparatus according to claim 23, further comprising a storage period determining device for determining a storage period of the record information recorded on the information recording medium,
said setting device changing the mark length in accordance with the storage period.

30. The information recording apparatus according to claim 29, wherein said storage period determining device determines the storage period in accordance with a type of the record information.

31. The information recording apparatus according to claim 29, wherein said setting device sets the recording conditions to increase the mark length in accordance with a length of the storage period.

32. The information recording apparatus according to claim 24, further comprising a strategy information obtaining device for obtaining strategy information including information about a standard pulse width of the pulse signal which drives the light source,
said setting device setting the recording conditions to change the mark length by changing the pulse width on the basis of the standard pulse width corresponding to the obtained strategy information.

33. The information recording apparatus according to claim 24, further comprising a disc attribute information obtaining device for obtaining disc attribute information from the information recording medium and obtaining strategy information about the information recording medium on the basis of the obtained disc attribute information,
said setting device setting the recording conditions to change the mark length by changing the pulse width on the basis of the standard pulse width corresponding to the obtained strategy information.

34. The information recording apparatus according to claim 24, wherein said setting device sets a first recording condition in which a change in reproduction quality corresponding to a temporal change in features of the information recording medium is relatively reduced, as the recording conditions.

35. The information recording apparatus according to claim 23, wherein said setting device sets the recording conditions to change the mark length by increasing the pulse width.

36. The information recording apparatus according to claim 23, wherein said setting device sets the recording conditions to change the mark length by increasing a recording power or light quantity of the laser beam applied from the light source.

37. The information recording apparatus according to claim 22, wherein said setting device sets the recording conditions to change a mark length of another record mark, except the shortest or second shortest record mark, of the plurality of types of lengths.

38. The information recording apparatus according to claim 22, wherein said setting device sets the recording conditions after a predetermined recording power is detected for the information recording medium.

39. The information recording apparatus according to claim 22, wherein a temporal change in features of the information recording medium is shown by a predetermined table, and the predetermined table can be corrected by a correction coefficient.

40. The information recording apparatus according to claim 22, wherein
said setting device (i) sets a short-term recording condition in accordance with a relatively short-term temporal change in features of the information recording medium and (ii) sets a long-term recording condition in accordance with a relatively long-term temporal change in the features of the information recording medium, and
said controlling device controls said recording device to record the record marks on the basis of the set short-term recording condition and the set long-term recording condition.

41. An information recording method comprising:
a recording process of recording record information by applying a laser beam from a light source to an information recording medium and thus recording record marks with a plurality of types of lengths;
a setting process of setting recording conditions in accordance with a change occurring the record marks with time; and
a controlling process of controlling said recording process to record the record marks on the basis of the set recording conditions.

42. A computer program for recording control to control a computer provided for an information recording apparatus,
said computer program making the computer function as at least one portion of a recording device, a setting device, and a controlling device,
said information recording apparatus comprising;
said recording device for recording record information by applying a laser beam from a light source to an information recording medium and thus recording record marks with a plurality of types of lengths;
said setting device for setting recording conditions in accordance with a change occurring the record marks with time; and
said controlling device for controlling said recording device to record the record marks on the basis of the set recording conditions.
